(19) United States
(12) Patent Application Publication
(10) Pub. No.: US 2007/0038894 A1
(43) Pub. Date: Feb. 15, 2007

(54) Test Data verification with different granularity levels

(75) Inventors: Gjergji Stasa, Kirkland, WA (US); Bogdan Popp, Sammamish, WA (US); Carlos Aguilar, Redmond, WA (US); Clayton M. Compton, Bellevue, WA (US); Faris A. Sweis, Seattle, WA (US); Leonid A. Tsybert, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/199,604

(22) Filed: Aug. 9, 2005

(51) Int. Cl. G06F 11/00

(52) U.S. Cl. 714/38

(57) ABSTRACT

Test data is generated by executing code in a software application. The test data may be verified using a verification module. The code is executed based on test conditions. The verification module accesses a verification reference to obtain verification rules and values. Each verification rule is associated with values that are used to compare the test data and the verification rule. The verification rules are used to evaluate the test results to determine whether the test results comply with expected results. Based on the evaluation, a determination is made whether the software application under test functioned properly.

### BACKGROUND

Various aspects of a software computer program are commonly tested to verify functionality before the software is ready to be used by an end user. Testing various software functions increases in difficulty as the software becomes more complex. The time and expense associated with verification increases when the testing process becomes more difficult.

Testing an application may be accomplished by controlling the inputs to the application, and then monitoring the outputs. For example, a test system may comprise an input system, a software application to be tested, and a verification module. The input system may input test conditions to the software application. The software application then outputs a result to the verification module. The verification module determines whether the program has functioned properly by comparing the result to validated results. The verification module outputs a “pass” or “fail” signal based on the comparison.

The verification component of a test case may be compiled as part of an automated test case. If the test conditions require even a slight modification, however, the entire test case must be recompiled. Continuous recompilation hampers system scalability. For example, as test conditions become more complicated and contain more variables, there is an increased need to modify test cases. Thus, such a testing procedure becomes more tedious as program complexity increases.

### SUMMARY

Test data is generated by executing code in a software application. The test data may be verified using a verification module. The code is executed based on test conditions received from an input module. The verification module accesses a verification reference to obtain verification rules and values. Each verification rule is associated with values that are used to compare the test data and the verification reference data.

The verification rules are used to evaluate the test results to determine whether the test results comply with expected results. If the test results comply with expected results, the verification module generates a “pass” verification result. If the test results do not comply with expected results, the verification module generates a “fail” verification result. A tester may then determine whether or not the software application is functioning properly based on the verification result.

The verification rules may include various verification rules that address different granularity levels. For example, the verification rules may include body string verification rules, exact response verification rules, regular expression verification rules, tag verification rules, and/or resource verification rules. Each of the different verification rules may have various properties that apply when the verification reference is called. Any of the verification rules may be used to verify the test data of the software application under test.

The verification reference employs a hierarchal inheritance structure. The verification reference may include both base verification rules and verbose verification rules. A base verification rule is software application independent and includes values that apply to the test results when the verification reference is called. A verbose verification rule is specific to the software application under test and has descriptive values which may relate directly to the functionality of the software application under test. A verbose verification rule may inherit values and functionality from base verification rules.

The verification reference may also include various contexts. A context identifies environment settings in which the software application is tested. The verification module selects the verification rules based on the context that matches the environment settings of the software application under test. Software applications may be verified according to a different testing process depending on the context. The different contexts may cause different corresponding results to be equated. Each context may also contain various scenarios to be tested under different input conditions. The verification module selects the verification rules to access the scenario data that is relevant to the environment settings of the software application under test. Different scenarios correspond to different actions that are performed when a software application is tested.

Other aspects of the invention include system and computer-readable media for performing these methods. The above summary of the present disclosure is not intended to describe every implementation of the present disclosure. The figures and the detailed description that follow more particularly exemplify these implementations.

### BRIEF DESCRIPTION OF THE DRAWINGS

FIG. 1 is a functional block diagram illustrating an exemplary computing device that may be used in one aspect of the present invention.

FIG. 2 is a functional block diagram illustrating an exemplary system for verifying test data.

FIG. 3 is a functional block diagram illustrating an exemplary embodiment of a verification reference.

FIG. 4 is a functional block diagram illustrating another exemplary embodiment of a verification reference.

FIG. 5 is a functional block diagram illustrating yet another exemplary embodiment of a verification reference.

FIG. 6 is an operational flow diagram illustrating a process for verifying test data.

### DETAILED DESCRIPTION

Test data is generated by executing code in a software application. The test data may be verified using a verification module. The code is executed based on test conditions received from an input module. The verification module accesses a verification reference to obtain verification rules and values. Each verification rule is associated with values that are used to compare the test data and the verification reference. The verification rules are used to evaluate the test results to determine whether the test results comply with expected results. A tester may then determine whether or not the software application is functioning properly based on the verification result.

The verification reference employs a hierarchal inheritance structure. The verification reference may include both base verification rules and verbose verification rules. A base verification rule is software application independent and includes values that apply to the test results when the verification reference is called. A verbose verification rule is specific to the software application under test and has descriptive values that may relate directly to the functionality of the software application under test. A verbose verification rule may inherit values and functionality from base verification rules.

The verification reference may also include various contexts. A context identifies environment settings in which the software application is tested. The verification module selects the verification rules based on the context that matches the environment settings of the software application under test. Software applications may be verified according to a different testing process depending on the context. Each context may also contain various scenarios to be tested under different input conditions. The verification module selects the verification rules to access the scenario data that is relevant to the environment settings of the software application under test. Different scenarios correspond to different actions that are performed when a software application is tested.

Embodiments of the present invention are described in detail with reference to the drawings, where like reference numerals represent like parts and assemblies throughout the several views. Reference to various embodiments does not limit the scope of the disclosure, which is limited only by the scope of the claims attached hereto. The examples set forth in this specification are not intended to be limiting and merely set forth some of the many possible embodiments. The following detailed description is, therefore, not to be taken in a limiting sense.

Illustrative Operating Environment

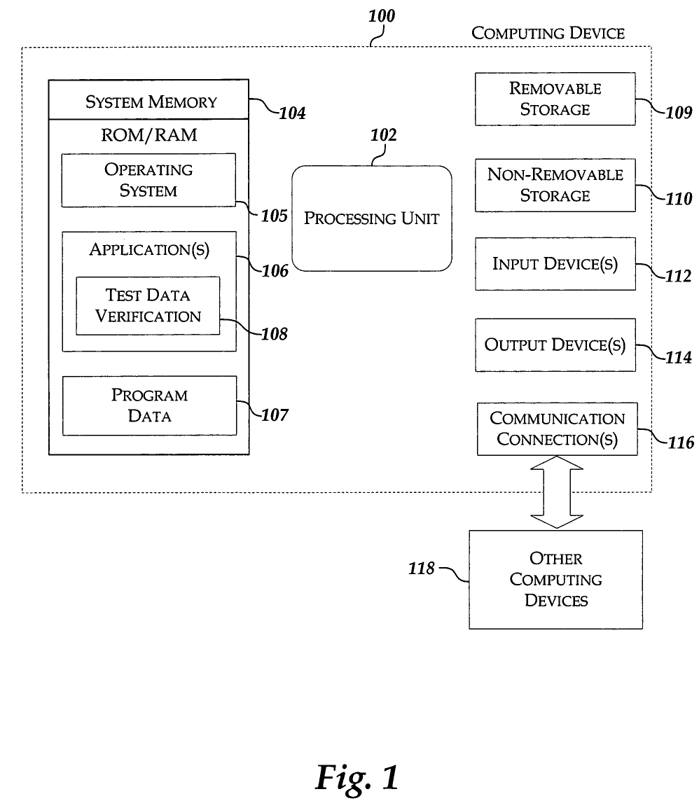

Referring to FIG. 1, an exemplary system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include test data verification application 108 that is discussed in further detail below.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication connection(s) 116 that allow the device to communicate with other computing devices 118, such as over a network or a wireless mesh network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Test Data Verification with Different Granularity Levels

The present disclosure is described in the general context of computer-executable instructions or components, such as software modules, being executed on a computing device. Generally, software modules include routines, programs, objects, components, data structures, and the like that perform particular tasks or implement particular abstract data types. Although described here in terms of computer-executable instructions or components, the invention may equally be implemented using programmatic mechanisms other than software, such as firmware or special purpose logic circuits.

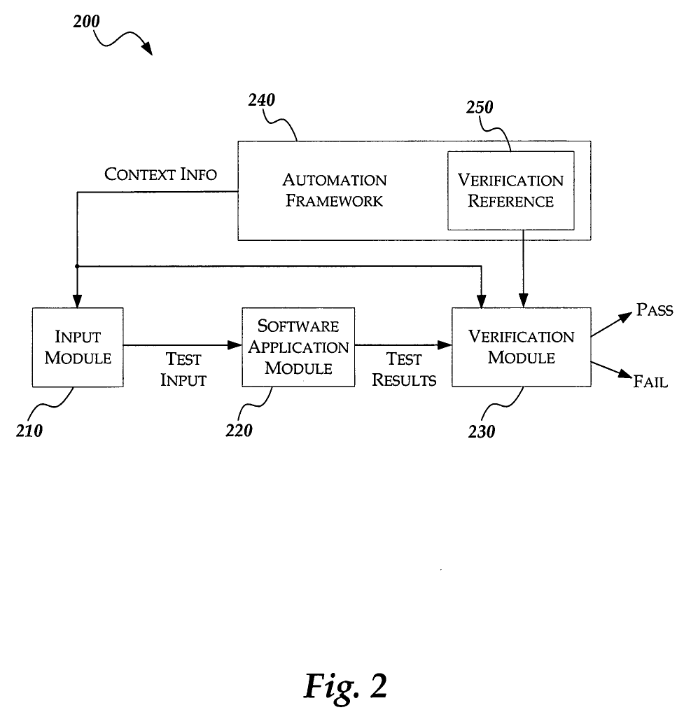

FIG. 2 is a functional block diagram illustrating an exemplary system for verifying test data. The system 200 includes input module 210, a software application under test module 220, verification module 230, automation framework 240 and verification reference 250. Automation framework 240 is independent of verification module 230 to enhance scalability and flexibility of the testing process. In one embodiment, automation framework 240 is encapsulated in an application-specific layer to simplify integration with automated testing systems. When planned functional changes are detected in the software application under test, rules defined in verification reference 250 may be easily updated to accommodate the new developments without changing any test case code. Test case sources may also be easier to maintain in the long term. For example, if test requirements change (e.g., support for a new platform, new browser) new verification rules may be globally applied without affecting test case code. This componentized approach to verification reduces instability in the test case code.

Automation framework 240 may be arranged to obtain context information from verification reference 250. The context information describes a set of circumstances that define appropriate test conditions for software application module 220. Input module 210 may be arranged to receive the context information from automation framework 240. Input module 210 may further be arranged to output appropriate test conditions. The test conditions are a set of parameters under which software application module 220 is tested. Software application module 220 may be arranged to receive test input from the input module 210. Software application module 220 may further be arranged to output test results when software application module 220 is tested based on the parameters.

Verification module 230 may be arranged to receive verification reference 250, the test results and the context information. Verification reference 250 is parsed and a verification object is instantiated such that proper context values and verification rules to be applied to the test results are generated and passed to verification module 230. Verification module 230 outputs a “pass” or “fail” result when the verification rules and the context values are applied to the test results. A tester may then determine whether software application module 220 is functioning properly based on the resulting “pass” or “fail” result.

In one embodiment, verification rules may be defined in a verification file. The verification file may be an XML file that is deployed to a directory that includes a test case configuration file. One verification file is applied to the test case. Another verification file may be shared among different test cases in a predetermined area. For example, a test may be arranged such that all the test cases in the area with a certain error would fail based on the shared verification file. The shared verification file allows modifications to be easily implemented across multiple test cases.

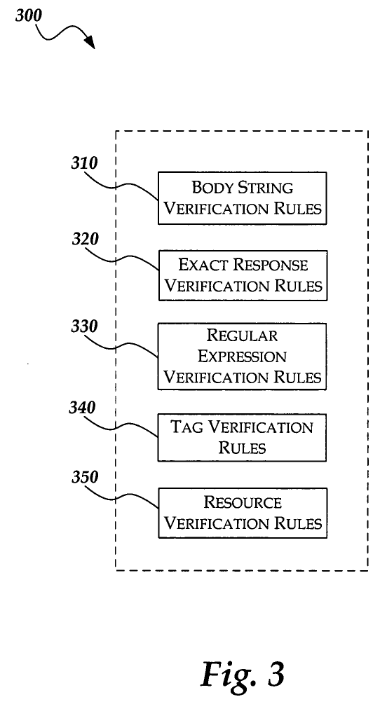

FIG. 3 is a functional block diagram illustrating an exemplary embodiment of a verification reference, such as verification reference 300. Verification reference 300 may include various verification rules that address different granularity levels. For example, verification reference 300 may contain body string verification rules 310, exact response verification rules 320, regular expression verification rules 330, tag verification rules 340, or resource verification rules 350. Each of the different verification rules may have various properties that apply when the verification reference is called. Any of the verification rules may be used to verify the test data of the software application under test. The verification rules may be applied to the test results to determine general application attributes (e.g., whether a text string is present, whether a text string is not present, the order of specific terms, the number of times a text string appears, etc.) In one embodiment, verification reference 300 is a text file. In another embodiment, verification reference 300 is a markup language file. For example, verification reference 300 may be an XML file, and each base verification rule may be an element in the XML file. Modifications made to verification reference 300 (e.g., the XML file) do not require recompilation of test binaries. Thus, scalability of the test data verification process is improved. Verification reference 300 may be parsed by an XML serializer. The XML serializer supports conversion between an XML element and a class.

A body string verification rule 310 may instruct the verification module to search the test results to determine if a specific string is present. For example, if the test results are a text file, a body string verification rule may be used to determine if a specific string is located anywhere within the text of the test results. Thus, the test results other than the desired string are ignored.

Other forms of body string verification rules do not require an exact match. For example, a regular expression verification rule 330 may be used to instruct the verification module to search the test results to determine if an expression is present that matches a specified format. The verification module is instructed to search for a specific data pattern. For example, a regular expression rule may used to determine if a specific date format is present in the test results without regard to a specific date. This may be accomplished by passing a date format argument (e.g., “\d+/\d+/\d\d\d\d”) to the regular expression verification rule. The verification module searches the test results for any date matching the format specified in the argument. For example, both “1/1/2000” and “12/20/1980” would return a “pass” result. Other date formats (e.g., January 1, 2000 or 1/1/00) would return a “fail” result.

Body string verification rules may also use dynamic substitution for increased flexibility and extensibility. Dynamic substitution changes the target of a verification rule to search for a string of varying value in the test results. For example, a body string verification rule may be used to search the test results for the current date. This may be accomplished by passing an argument, such as “System.DateTime.Now”, to the verification module. The search term varies depending on when the search is conducted. In other words, the verification module searches for the current date without regard to when the test is conducted.

The verification reference may also contain exact response verification rules 320. An exact response verification rule instructs the verification module to match the test results to a reference while ignoring specified portions of the test results. For example, an exact response verification rule may instruct the verification module to ignore sections of the test result between specific characters. In one embodiment, test result content between “-<” and “>-” is ignored. Thus, all of the content in the test results is verified except the content between the specified characters. In other words, the portions of the test results not between the specified characters are compared with the verification reference. The sections of the test results that are ignored do not affect the test outcome. The content in the test results may correspond to text, binary code, HTML, XML, etc. Exact response verification rules 320 may be useful when verifying content that includes large amounts of data that is not relevant to the functionality under test. In one embodiment, exact response verification rules 320 are associated with a dictionary of content and corresponding limiters that may be extracted for verification.

Exact response verification rules 320 function in a complimentary manner to body string verification rules 310. That is, a body string verification rule verifies a specific portion of the test results, while ignoring the remaining portions. On the other hand, an exact response verification rule verifies all of the test results, while ignoring a specific portion.

Verification reference 300 may also contain tag verification rules 340. A tag verification rule may instruct the verification module to search the test results for specific formatting by localizing content defined by a markup language tag. Tag verification rules 340 have several features to increase the extensibility of the verification module. For example, a tag verification rule may be established to ignore certain attributes or elements in a markup language document. A tag verification rule may also establish whether the order of elements in the document is important. A tag verification rule may also be used to search the test results for specific subcontent using HTML, XML or another markup language. Regular expressions may be used for attribute values in a tag verification rule. Resources from a dynamic link library may be used to provide localized text in the tag verification rule. The entire content of a tag verification rule may be dynamically generated at execution time such that the verification rule is customized using values known at runtime. Resource verification rules 350 verify test result elements that are essentially identical but are not exact string matches. For example, “new” in English has essentially the same meaning as “nueva” in Spanish. The use of body string rules would produce a “fail” result. A resource verification rule overcomes this problem by associating a resource identifier with a string. The resource identifier is associated with different strings that are essentially the same. During verification, the resource identifier is accessed in a dynamic link library such that different strings that are associated with the same resource identifier are treated as exact matches.

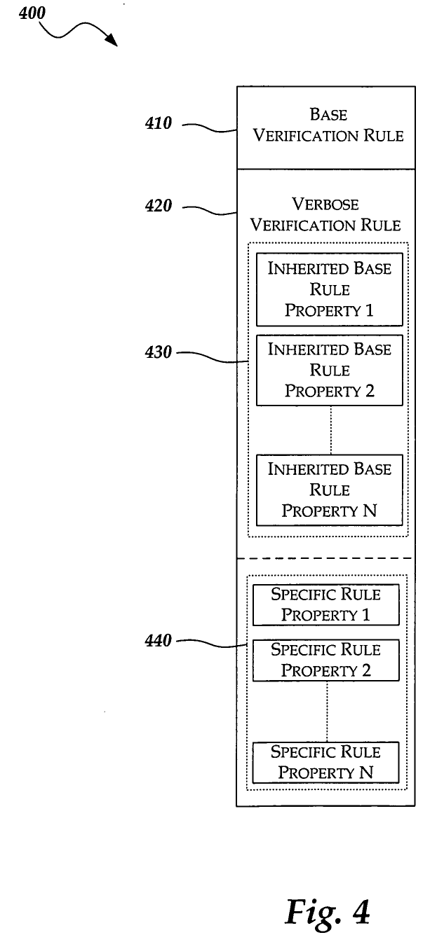

FIG. 4 is a functional block diagram illustrating another exemplary embodiment of a verification reference, such as verification reference 400. Verification reference 400 employs a hierarchical inheritance structure. Verification reference 400 may include base verification rules, such as base verification rule 410. A base verification rule is software application independent and includes rules and values that apply to the test results when the verification reference is called. Base verification rule 410 may be any verification rule. For example, base verification rule 410 may be a body string rule, an exact response rule, a regular expression rule, a tag verification rule, a resource verification rule, etc. Base verification rule 410 may also include base rule properties 420. For example, if base verification rule 410 is an exact response rule, base verification rule 410 contains base rule properties including instructions to ignore specified portions of the test results.

Verification reference 400 may also include verbose verification rules, such as verbose verification rule 420. A verbose verification rule is specific to the software application under test and has descriptive values that may relate directly to the functionality of the software application under test. A verbose verification rule may inherit values and functionality from base verification rule 410, such as inherited properties 430. Verbose verification rule 420 may also contain specific rule properties 440 that are unique to each verbose verification rule.

For example, if base verification rule 410 is an exact response verification rule, each verbose verification rule 420 is an extended instance of an exact response verification rule. Thus, each verbose exact response verification rule inherits properties from the base exact response verification rule 410, including instructions to ignore specified portions of the test results. Each verbose exact response verification rule 420 also has specific properties as defined by specific rule properties 440. For example, specific rule properties 440 may define a portion of the test results to be ignored.

In one embodiment, the verification rules are specified in a hierarchy of files. For example, a tester may apply a new set of verification rules for a specific context or configuration by adding a new XML file. Settings in the new file are merged with the verification rules in another XML file. The hierarchy of files enables the tester to globally establish a set of new rules without accessing any test case verification files.

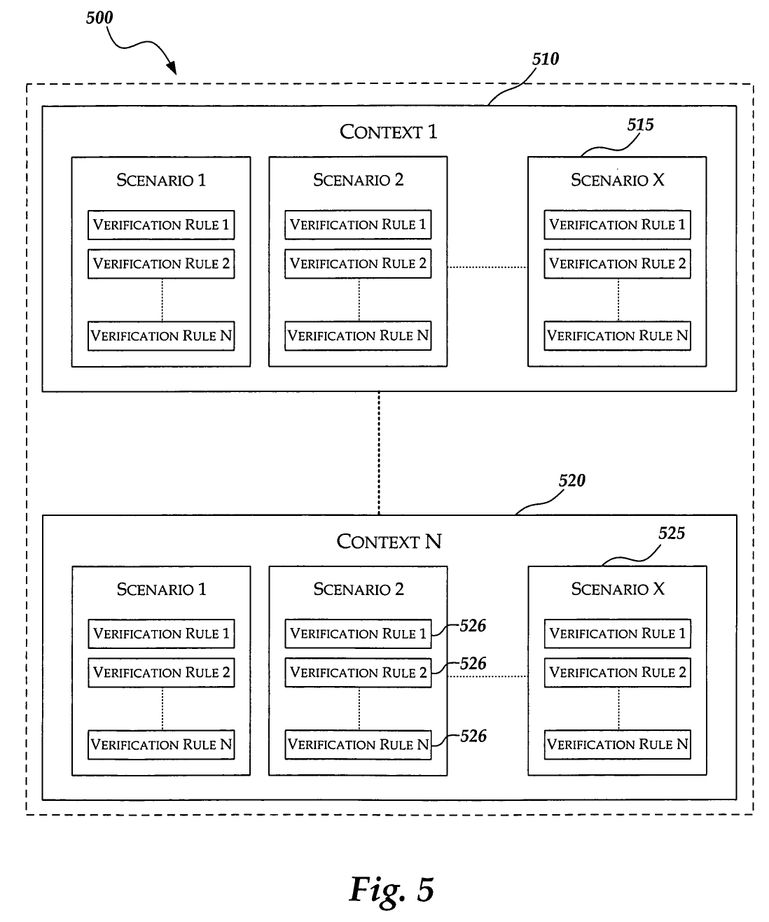

FIG. 5 is a functional block diagram illustrating yet another exemplary embodiment of a verification reference, such as verification reference 500. Verification reference 500 may include various contexts, such as contexts 510, 520. A context identifies environment settings in which the software application is tested. For example, various contexts may correspond to different operating systems that the software application under test may be applied to. Contexts may also correspond to different languages (e.g., English and Japanese) that the software application under test may support. In another example, contexts may correspond to different applications (e.g., Netscape Navigator and Internet Explorer). Thus, objects in different applications may be verified according to a different testing process depending on the context.

The different contexts may cause different corresponding results to be equated. For example, an English string and a corresponding Japanese string that are otherwise the same would both produce a “pass” result. Various contexts may also exist for combinations of parameters. In other words, context 510 may apply to an operating system when using English, while context 520 may apply to the same operating system when using Japanese.

Each context may also contain various scenarios, such as scenarios 515, 525, to be tested under different input conditions. Different scenarios correspond to different actions that are performed when a software application is tested. Example scenarios may cause the following actions to be performed: start an application, create a new file, open a file, delete file content, close a file, etc. Context 510 may contain separate scenarios for different sets of input conditions being tested. Each individual scenario may contain individual verification rules, such as verification rules 526, to test specific input conditions under a specific operating environment.

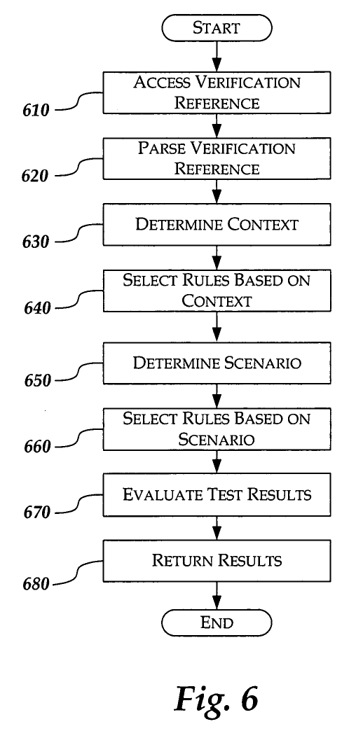

FIG. 6 is an operational flow diagram illustrating a process for verifying test data. Processing begins at a start block where a software application test is performed. For example, a control on a web page may be tested to determine its functionality. The software application is tested by executing code in the software application. The code is executed based on test conditions that define a set of parameters. Test results are produced in response to the executed code.

A verification module accesses a verification reference at block 610. The verification reference includes base and/or verbose verification rules. The verification rules may include body string verification rules, exact response verification rules, regular expression verification rules, tag verification rules, and/or resource verification rules. Each verification rule addresses different granularity levels. Each verification rule is associated with values that are used to compare the test data and the verification reference. In one embodiment, the verification reference is an XML file and each verification rule is an XML element. In another embodiment, the verification reference is included in a verification file. The verification file provides the verification reference to verify other test results in a predetermined area. The shared verification profile allows modifications to be easily implemented across multiple test results.

Moving to block 620, the verification reference is parsed and a verification object is instantiated such that the verification rules and values are obtained. In one embodiment, the verification reference is parsed using an XML serializer when the verification reference is an XML file. In another embodiment, the verification rules include a verbose verification rule that is specific to the software application under test. The verbose verification rule may include descriptive values that relate to the functionality of the software application under test. The verbose verification rule may inherit values and functionality from a base verification rule.

Transitioning to block 630, the verification module determines from the verification values a context which applies to the software application under test. The context may identify environment settings in which the software application is tested. Proceeding to block 640, the verification rules are selected based on the context that matches the current environment settings of the software application under test. For example, if the software application is to be verified using verification rules associated with a first context, all verification rules not associated with the first context are ignored.

Advancing to block 650, the verification module determines which scenario is being tested. Different scenarios are tested based on input conditions of a specific operating environment. A scenario may identify an action or a set of actions to be performed when the software application is tested. Continuing to block 660, the verification rules are further selected to access scenario data that is relevant to the environment settings of the software application under test. For example, if the software application is to be verified using verification rules associated with a first scenario, all verification rules not associated with the first scenario are ignored.

Moving to block 670, the relevant verification rules are used to evaluate the test results to determine whether the test results comply with expected results. A determination is made whether the test passed or failed based on the evaluation. The pass/fail results may depend on the results of each of the individual verification rules. In some embodiments, the result may be determined if a string is present or not present. In other embodiments, the result may be determined based on the number of times a string is present. In still other embodiments, the result may be determined based on the order of specific strings. In yet other embodiments, the result may be determined based on a combination of such factors.

Processing continues at block 680 where the pass/fail results are returned. The returned pass/fail results may be used by a tester to determine whether the software application under test functioned properly. The result may then be logged for each rule. Processing then terminates at an end block.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A computer-implemented method for verifying a test result associated with a software application, comprising:
receiving a verification reference, wherein the verification reference comprises verification rules;
executing code in the software application, wherein the code is executed based on test conditions;
generating the test result based on the executed code;
selecting a verification rule from the verification reference;
evaluating the test result based on the selected verification rule; and
generating a verification result based on the evaluation.

2. The computer-implemented method of claim 1, wherein the selected verification rule comprises a body string verification rule, and further wherein evaluating the test result based on the selected body string verification rule comprises searching the test result for content identified in the body string verification rule.

3. The computer-implemented method of claim 2, wherein the content identified in the body string verification rule dynamically varies based on a predetermined variable.

4. The computer-implemented method of claim 1, wherein the selected verification rule comprises an exact response verification rule, and further wherein evaluating the test result based on the selected exact response verification rule comprises:
identifying a portion of the test result that is evaluated based on the selected verification rule; and
searching the identified portion of the test result for content identified in the exact response verification rule.

5. The computer-implemented method of claim 1, wherein the selected verification rule comprises a regular expression verification rule, and further wherein evaluating the test result based on the selected regular expression verification rule comprises:
identifying a data pattern in the selected regular expression verification rule; and
searching the test result for content corresponding to the identified data pattern.

6. The computer-implemented method of claim 1, wherein the selected verification rule comprises a tag verification rule, and further wherein evaluating the test result based on the selected tag verification rule comprises searching the test result for content corresponding to a markup language tag identified in the selected tag verification rule.

7. The computer-implemented method of claim 1, wherein the selected verification rule comprises a resource verification rule, and further wherein evaluating the test result based on the selected resource verification rule comprises:
associating a first string and a second string with a resource identifier;
searching the test result for content identified in the selected resource verification rule, wherein the content is associated with the resource identifier; and
determining whether the content corresponds to the first string or the second string based on context information associated with the selected resource verification rule.

8. The computer-implemented method of claim 1, wherein selecting the verification rule comprises selecting the verification rule based on a scenario, and further wherein the scenario identifies an action to be performed when the code in the software application is executed.

9. The computer-implemented method of claim 1, wherein selecting the verification rule comprises selecting the verification rule based on a context, and further wherein the context identifies environment settings in which the software application is tested.

10. The computer-implemented method of claim 1, wherein selecting a verification rule further comprises selecting a verbose verification rule, and further wherein the verbose verification rule inherits functionality and values from a base verification rule.

11. The computer-implemented method of claim 1, further comprising modifying the verification reference based on the verification result.

12. The computer-implemented method of claim 1, wherein receiving the verification reference further comprises receiving the verification reference from a verification file, and further wherein the verification file provides the verification reference to verify other test results.

13. A system for verifying a test result associated with a software application, comprising:
an input module that is arranged to generate test data;
a software application module coupled to the input module, wherein the software application module is arranged to:
receive the test data from the input module,
execute code based on the test data, and
generate a test result based on the executed code;
a verification reference comprising verification rules; and
a verification module coupled to the software application module, wherein the verification module is arranged to:
receive the test result from the software application module,
receive the verification rules from the verification reference,
select one verification rule,
evaluate the test result based on the selected verification rule, and
generate a verification result based on the evaluation.

14. The system of claim 13, wherein the verification rule comprises one of: a body string verification rule, an exact response verification rule, a regular expression verification rule, a tag verification rule, and a resource verification rule.

15. The system of claim 13, wherein the verification module selects the verification rule based on a scenario, and further wherein the scenario identifies an action to be performed when the software application module executes the code.

16. The system of claim 13, wherein the verification module selects the verification rule based on a context, and further wherein the context identifies environment settings in which the software application module is tested.

17. The system of claim 13, wherein the verification module is further arranged to select a verbose verification rule, and further wherein the verbose verification rule inherits functionality and values from a base verification rule.

18. A computer-readable medium having computer-executable instructions for verifying test data associated with a software application, comprising:
receiving a verification reference, wherein the verification reference comprises verification rules;
executing code in the software application, wherein the code is executed based on test conditions;
generating the test result based on the executed code;
selecting a verification rule from the verification reference based on context, wherein the context identifies environment settings in which the software application is tested;
evaluating the test result based on the selected verification rule; and
generating a verification result based on the evaluation.

19. The computer-readable medium of claim 18, wherein selecting the verification rule further comprises selecting the verification rule based on a scenario, and further wherein the scenario identifies an action to be performed when the code in the software application is executed.

20. The computer-readable medium of claim 18, wherein selecting a verification rule further comprises selecting a verbose verification rule, and further wherein the verbose verification rule inherits functionality and values from a base verification rule.
